(19) United States
(12) Patent Application Publication
(10) Pub. No.: US 2010/0289457 A1
(43) Pub. Date: Nov. 18, 2010

(54) ENERGY EFFICIENT AND FAST CHARGE MODES OF A RECHARGEABLE BATTERY

(75) Inventors: Per Onnerud, Framingham, MA (US); Phillip E. Partin, Grafton, MA (US); Eckart W. Jansen, Belmont, MA (US); Scott Milne, Boston, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Boston-Power, Inc., Westborough, MA (US)

(21) Appl. No.: 12/781,620

(22) Filed: May 17, 2010

Related U.S. Application Data
(60) Provisional application No. 61/179,182, filed on May 18, 2009.

(51) Int. Cl. H02J 7/04; H02J 7/00

(52) U.S. Cl. 320/162; 320/160

(57) ABSTRACT

A method of providing power to an electronic device in an energy-efficient manner includes transitioning between power states corresponding to charging and discharging a battery. The state of charge of the battery is detected. Upon detecting a high threshold state of charge, an external power source such as an AC-to-DC adapter is disabled, and the battery to provides primary power to the electronic device. Upon a low threshold state of charge, the AC-to-DC adapter is controlled to provide a high current output to charge the battery and provide primary power to the electronic device. The power states, when cycled over time based on the state of the battery, provide for an energy-efficient method of powering the electronic device.

### RELATED APPLICATIONS

This application claims the benefit of U.S. Provisional Application No. 61/179,182, filed on May 18, 2009, the entire teachings of which are incorporated herein by reference.

### BACKGROUND OF THE INVENTION

The portable power industry has traditionally been using charge rates between 0.7 C and 1 C when charging electronic devices, which is the rate used for laptop computers. This current allows the notebook computer's battery pack to be charged at currents that are 70% to 100% of the value of rated capacity of the cells. For example, in a battery pack containing 18650 cells, rated at 2.2 Ah, in a 2p3s configuration (two cells in parallel, three cells in series), a charging current of 1 C would be equivalent to a charging current of 4.4 A for the pack. This charging current is allowed until a maximum voltage (Vₘₐₓ) is reached, which is typically set at about 4.2V. Once Vₘₐₓ has been reached, the current is lowered by control circuitry to disallow, in this example, any of the three blocks of two parallel cells to reach voltage levels higher than 4.2V. In addition to the current being limited, the charging rate is even slower once Vₘₐₓ has been reached. Electronic circuits managing this type of functionality are known in the art and have been implemented in battery packs for notebook computers. For a notebook computer, typical charging times are of several hours to reach a fully charged battery.

Safety and battery life are the main problems with providing faster charging. Practically, for lithium ion (Li-ion) batteries during fast charging, batteries may locally display overcharging, which may deposit lithium onto the carbon anode. This lithium deposit lowers safety of the battery, which may more easily go into thermal runaway, increase its internal gas pressure, and eventually explode. Another problem with fast charging is the rapid change of electrode dimensions, such as thickness variation. Mechanical degradation of the electrode structure is faster during this relatively fast charge than what would be the case for slower charging. These limiting features concern all Li-ion batteries, more or less, depending on battery design. Batteries may be designed to take charge faster by limiting impact of detrimental aspects, such as safety and battery life.

However, for batteries having multiple cells in parallel, a particular concern arises when trying to quickly charge battery packs. This concern has to do with the imbalance of cells in parallel. Impedance and capacity degradation is different between cells due to differences between cells during manufacturing and environmental exposure after manufacturing (i.e., temperature, vibration, mechanical shock, etc.). This means that two cells, having initially similar conditions in terms of (i.e., capacity and impedance), will display different performance after a few months of use. Each block of parallel cells will be limited by the weakest cell, having lowest capacity and/or highest impedance, as this is the cell that will reach Vₘₐₓ earlier than the cell having better characteristics. As cycling progresses, the weakest cell will degrade even quicker, as it will always be the cell that experiences the most extreme conditions. Safety is also a concern as performance is decreased. The cell having the lowest performance will normally be the cell having the highest chance of being overcharged, thereby being a safety concern.

### SUMMARY OF THE INVENTION

Current notebook PCs and other battery powered devices do not provide a mechanism for the user to activate an environment-conserving power efficient charging and discharging mode of the battery pack, AC adapter and device. Furthermore, an economical communication method between the battery pack, AC adapter and device does not exist to notify these components of the selected power state.

Current devices such as notebook PCs also do not provide a mechanism for the user to activate an accelerated charging mode of the battery. Furthermore, the current required for such fast charging modes plus normal system loads will often exceed the power capacity of a typical AC adapter and will require the notebook to reduce power consumption itself in order to provide sufficient power for accelerated charging of the battery.

Embodiments of the present invention enable energy efficient power modes and fast charging modes in a notebook PC or other battery-powered device, battery pack and AC adapter.

Embodiments of the present invention include methods of providing power to an electronic device. Upon detecting a battery reaching a high threshold state of charge, a first power state is entered by switching a circuit to disable current at an AC-to-DC adapter and enabling the battery to provide primary power to the electronic device. Upon detecting the battery reaching a low threshold state of charge, a second power state is entered by switching the circuit to provide a high current at the AC-to-DC adapter to charge the battery and provide primary power to the electronic device. The first and second states, when cycled over time based on the state of the battery, may provide for an energy-efficient method of powering the electronic device by operating the AC-to-DC adapter at a high efficiency through high current output.

In further embodiments of the invention, the AC-to-DC adapter charges the battery at a high rate in the second power state, the high rate being greater than 1 C, 1.5 C or a greater multiple of 1 C dependent on a maximum safe charge rate of the battery. The battery may provide an indication of a maximum safe charge rate, which is detected and employed to select a current output of the AC-to-DC adapter. Further, the first and second power states may be alternated over time in response to detecting the high and low threshold charge states of the battery.

In still further embodiments of the invention, the first and second power states can be enabled in response to a user selection of an energy-efficient power mode to power the electronic device. This selection may be made among a plurality of different power and charge modes, including a “normal” power mode and a “fast” charge mode. Such modes can include a power state in which a circuit is switched to provide a low current at the AC-to-DC adapter to charge the battery at a low rate and provide primary power to the electronic device. The low rate of charge may be less than 1 C, such as a typical charge rage of 0.7 C. The higher current provided at the second power state may result in a higher energy efficiency operation of the AC-to-DC adapter.

In still further embodiments of the invention, characteristics of the AC-to-DC adapter may be detected, including output current and an indication of efficiency at a given output current, to determine a selection of output current in the second power state. Characteristics of the battery may also be detected to determine output current, including a maximum safe charge of the battery. The battery may be a lithium ion (Li-ion) battery, in particular a Li-ion battery capable of being safely charged at a rate greater than 1 C, 1.5 C or a multiple of 1 C.

In still further embodiments of the invention, a plurality of AC-to-DC adapters may be selected to provide the high current in the second power state. Such a selection may be based on an indication of maximum output current at each of the plurality of AC-to-DC adapters. The selection may further include power sources other than AC-to-DC adapters, such as a DC-to-DC adapter and an external battery. Selection among multiple power sources can be based on an indication of energy efficiency corresponding to a given current output at each of the power sources.

Further embodiments of the invention include an apparatus for providing power to an electronic device. The apparatus may include a power circuit configured to enable and disable power to the electronic device from a battery and an AC-to-DC adapter. A power circuit is configured to enable and disable power to the electronic device from a battery and an AC-to-DC adapter. Further, a controller is coupled to the power circuit and configured to transition between first and second power states as described above.

Still further embodiments of the invention may include a system for providing power to an electronic device. The system may include a battery and an AC-to-DC adapter, each configured to provide power to the electronic device, and a controller as described above to transition between first and second power states.

Further embodiments of the invention may include an electronic device that includes a device housing and a charge storage power supply coupled to the device housing. Electronics in the device housing are powered by the charge storage supply. A charge circuit has plural modes of operation to charge the charge storage power supply from an external power source at different charging rates. An actuated mode switch changes charging rates of the charging circuit. In one embodiment the actuated mode switch accelerates charging rate. In another embodiment the actuated mode switch decelerates charging rate. In still another embodiment, the actuated mode switch discharges the battery. The actuated mode switch can be manually operated or it can operate automatically.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 shows a functional block diagram of the electronic circuitry upon which the present embodiment may be implemented.

FIG. 2 illustrates a process flow diagram of an exemplary fast charge process.

FIG. 3A illustrates a fast charge button and display on a battery pack upon which the state-of-charge of a battery pack may also be shown.

FIG. 3B provides a close-up view of the aforementioned fast charge button and display on the battery pack of a portable device.

FIG. 4A illustrates a notebook computer with a “FAST CHARGE” button located on the keyboard.

FIG. 4B shows a close-up view of the “FAST CHARGE” button located on a notebook computer keyboard.

FIG. 4C shows an exemplary user interface display window that may appear to present a user with the option to initiate software that will perform the “fast charge” option of the portable device battery pack.

FIG. 5A is a block diagram of an electronic device and an associated charging system in which embodiments of the present invention may be implemented.

FIG. 5B is a block diagram showing the system of FIG. 5A in further detail.

FIG. 6 is a chart depicting a relation between power efficiency and operating load of an AC power adapter.

FIG. 7 is a state diagram illustrating a plurality of modes for charging a battery.

FIG. 8A is a flow diagram illustrating a method of initiating an energy-efficient charge mode.

FIG. 8B is a flow diagram illustrating a method of conducting an energy-efficient charge mode with reference to the system of FIG. 5B.

FIGS. 9A-C are timing diagrams illustrating AC adapter current and battery pack current during each of a plurality of charge modes.

### DETAILED DESCRIPTION OF THE INVENTION

A description of example embodiments of the invention follows.

The teachings of all patents, published applications and references cited herein are incorporated by reference in their entirety.

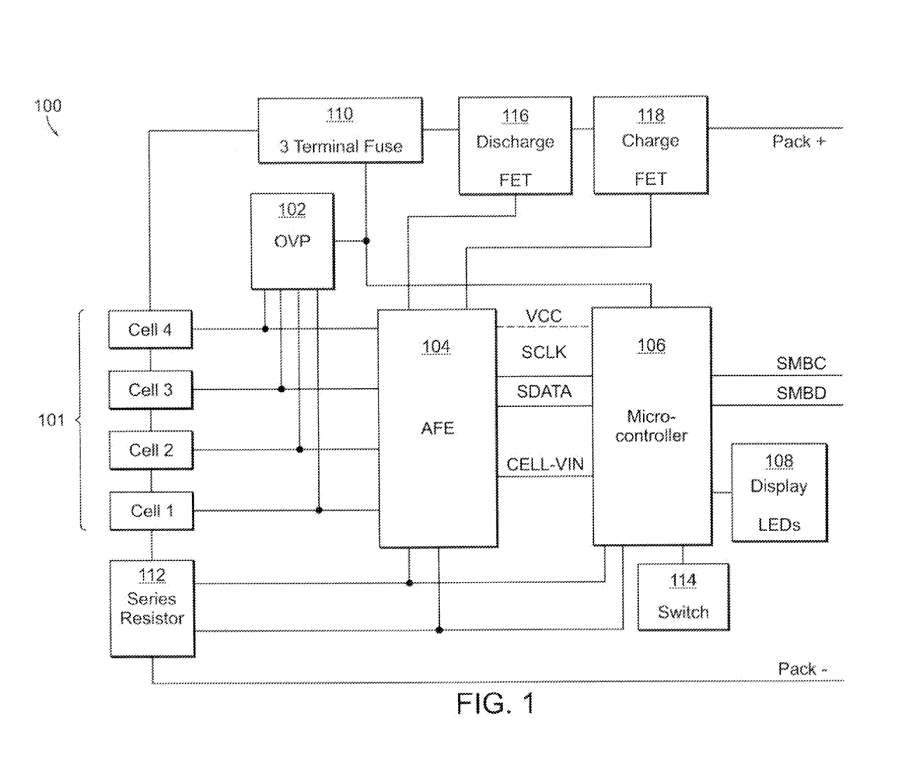

FIG. 1 illustrates a functional block diagram of the electronic circuitry 100 in a battery pack as used in current practice upon which the present embodiment may be implemented. In FIG. 1, a multiple cell battery 101 may be connected to an independent overvoltage protection integrated circuit (OVP) 102, an Analog Front End protection integrated circuit (AFE) 104, and a battery monitor integrated circuit microcontroller (microcontroller) 106. One with skill in the art will understand that the present invention is not limited to the aforementioned electronic circuitry of the schematic illustrated in FIG. 1.

The OVP 102 may allow for monitoring of each cell of the battery pack by comparing each value to an internal reference voltage. By doing so, the OVP 102 may be able to initiate a protection mechanism if cell voltages perform in an undesired manner, e.g., voltages exceeding optimal levels. The OVP 102 is designed to trigger the non-resetting fuse 110 if the preset overvoltage value (i.e., 4.35V, 4.40V, 4.45V, and 4.65V) is exceeded for a preset period of time and provides a third level of safety protection.

The OVP 102 may monitor each individual cell of the multiple cell battery 101 across the Cell 4, Cell 3 , Cell 2, and Cell 1 terminals (which are ordered from the most positive cell to most negative cell, respectively). The OVP 102 is powered by multiple cell battery 101 and may be configured to permit cell control for any individual cell of the multiple cell battery 101.

The AFE 104 may be used by the system host controller to monitor battery pack conditions, provide charge and discharge control via charge FET 118 and discharge FET 116 respectively, and to provide updates of the battery status to the system. The AFE 104 communicates with the microcontroller 106 to enhance efficiency and safeness. The AFE 104 may provide power via the VCC connection to the microcontroller 106 using input from a power source (e.g., the multiple cell battery 101), which would eliminate the need for peripheral regulation circuitry. Both the AFE 104 and the microcontroller 106 may have terminals, which may be connected to a series resistor 112 that may allow for monitoring of battery charge and discharge. Using the CELL terminal, the AFE 104 may output a voltage value for an individual cell of the multiple cell battery 101 to the VIN terminal of the battery monitor integrated circuit microcontroller 106. The microcontroller 106 communicates with the AFE 104 via the SCLK (clock) and SDATA (data) terminals.

The microcontroller 106 may be used to monitor the charge and discharge for the multiple cell battery 101. The microcontroller 106 may monitor the charge and discharge activity using the series resistor 112 placed between the negative cell of the multiple cell battery 101 and the negative terminal of the battery pack. The analog-to-digital converter (ADC) of the microcontroller 106 may be used to measure the charge and discharge flow by monitoring the series resistor 112 terminals. The ADC of the microcontroller 106 may be used to produce control signals to initiate optimal or appropriate safety precautions for the multiple cell battery 101. If the microcontroller 106 detects abnormal or unsafe conditions it will disable the battery pack by triggering the non-resetting fuse 110.

While the ADC of the microcontroller 106 is monitoring the voltage across the series resistor 112 terminals, the microcontroller 106 (via its VIN terminal) may be able to monitor each cell of the multiple cell battery 101 using the CELL terminal of the AFE 104. The ADC may use a counter to permit the integration of signals received over time. The integrating converter may allow for continuous sampling to measure and monitor the battery charge and discharge current by comparing each cell of the multiple cell battery 101 to an internal reference voltage. The display terminal of the microcontroller 106 may be used to run the LED display 108 of the multiple cell battery 101. The display may be initiated by closing a switch 114.

The microcontroller 106 may be used to monitor the multiple cell battery 101 conditions and to report such information to the host system controller across a serial communication bus (SMBus). The SMBus communication terminals (SMBC and SMBD) may allow a system host controller, SMBus compatible device, or similar device (hereinafter called “processor”) to communicate with the microcontroller 106. A processor may be used to initiate communication with the microcontroller 106 using the SMBC and SMBD pins, which may allow the system to efficiently monitor and manage the multiple cell battery 101. The processor may be the microcontroller 106 itself and may contain internal data flash memory, which can be programmed to include information, such as capacity, internal reference voltage, or other similar programmable information.

The AFE 104 and microcontroller 106 provide the primary and secondary means of safety protection in addition to charge and discharge control. Examples of current practice primary safety measures include battery cell and pack voltage protection, charge and discharge overcurrent protection, short circuit protection, and temperature protection. Examples of currently used secondary safety measures include monitoring voltage, battery cell(s), current, and temperature.

The continuous sampling of the multiple cell battery 101 may allow the electronic circuitry to monitor or calculate characteristics of a multiple cell battery 101, such as state-of-charge, temperature, charge, or the like. One of the parameters that is controlled by the electronic circuitry 100 is the allowed charging current (ACC). An aspect of the disclosed embodiments is to allow the user of a portable device to have the option to control this parameter by selecting a fast or slow charging mode. When selecting the mode of charging, the ACC parameter changes in addition to other parameters necessary to control the charging of the battery within safe limits. This allows a battery to be optionally charged faster than what would have been traditionally available. The user of the portable device may also control the charge mode by allowing the user to adjust the fast charge mode in steps (e.g., normal, fast, super fast, ultra fast, etc.) or on a continuous scale (e.g., 1×, 2×, 3×, 4×, etc.). A user may prefer to have more control over the fast charge mode parameter because such allows the user to balance performance (i.e., battery cycle life) against charge tradeoffs.

The program stored for the battery monitor integrated circuit microcontroller 106 may be modified to implement the fast charge indications described herein. The electronic circuit in FIG. 1 could be programmed with parameters suitable for the respective battery used in the battery 101. Each battery manufacturer has unique chemistry and interpretation of how the battery may be used in best mode to provide long cycle life, high capacity, and high safety. One with skill in the art will understand that a microcontroller used in accordance with the present invention is not limited to the design of FIG. 1.

It is preferred, though not required, that the cells in a multiple cell battery 101 be in series due to different impedances of the cells. Impedance imbalance may result from temperature gradients within the pack and/or manufacturing variability from cell to cell. Two cells having different impedances may have approximately the same capacity when charged slowly. It may be seen that the cell having the higher impedance reaches its upper voltage limit (Vₘₐₓ) in a measurement set (e.g., 4.2V) earlier than the other cell. If these two cells were in parallel in a battery pack, the charging current would therefore be limited to one cell's performance, which prematurely interrupts the charging for the other cell in parallel. This degrades both pack capacity as well as pack charging rate. In order to avoid these detrimental effects, it is therefore preferred for the current embodiments to utilize battery packs having only one cell or all cells in series having a fast charge option. Such preferred configurations are described in PCT/US2005/047383, and U.S. Provisional Application No.'s 60/639,275; 60/680,271; and 60/699,285; which are hereby incorporated by reference in their entireties. A preferred battery is disclosed in a U.S. application Ser. No. 11/474,081 (U.S. Pub. 2007/0298314) for “Lithium Battery With External Positive Thermal Coefficient Layer,” filed Jun. 23, 2006, by Phillip Partin and Yanning Song, incorporated by reference in its entirety.

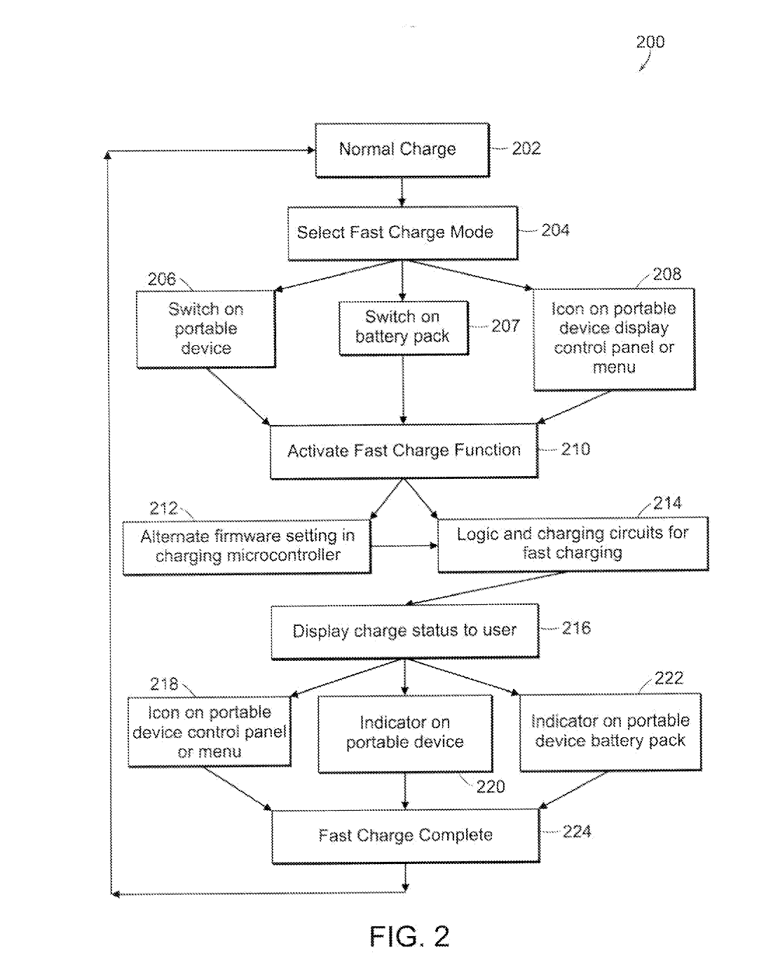

FIG. 2 illustrates a process flow diagram of an exemplary fast charge process 200 where a user is presented with the option of choosing the normal charge mode (Step 202) of the portable device battery pack. If the user opts to use the fast charge mode (Step 204), the user can do so via one of three mediums: a switch on the portable device (Step 206), a switch on the battery pack (Step 207), or an icon on the portable device display control panel or menu (Step 208), any one ore more of which may be available. From either of the three mediums, the user can initiate the fast charge function (Step 210). The initiation of the fast charge function (Step 210) can be done either by an alternate firmware setting in the charging battery monitor integrated circuit microcontroller 106 (Step 212) or the logic and charging circuits for fast charging (Step 214). The alternate firmware setting in charging the battery monitor integrated circuit microcontroller 106 (Step 212) then uses the logic and charging circuits for fast charging (Step 214). After using the logic and charging circuits for fast charging (Step 214), the process will display the charge status to the user (Step 216), which can occur in one of the following mediums: an icon on the portable device control panel or menu (Step 218), an indicator on the portable device (i.e., LED display 108) (Step 220), or an indicator on the portable device battery pack (Step 222). After using either of the three mediums to display the charge status to the user (Step 216), the fast charge process 200 is complete (Step 224). After the fast charge process 200 is completed (Step 224), the portable device battery pack may return to normal charge mode (Step 202).

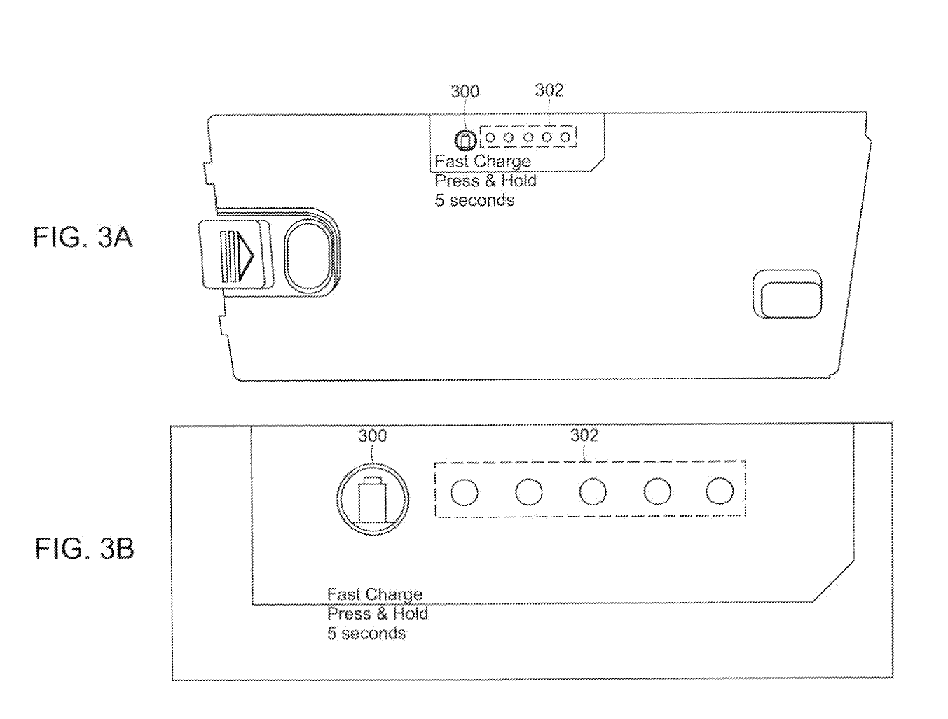

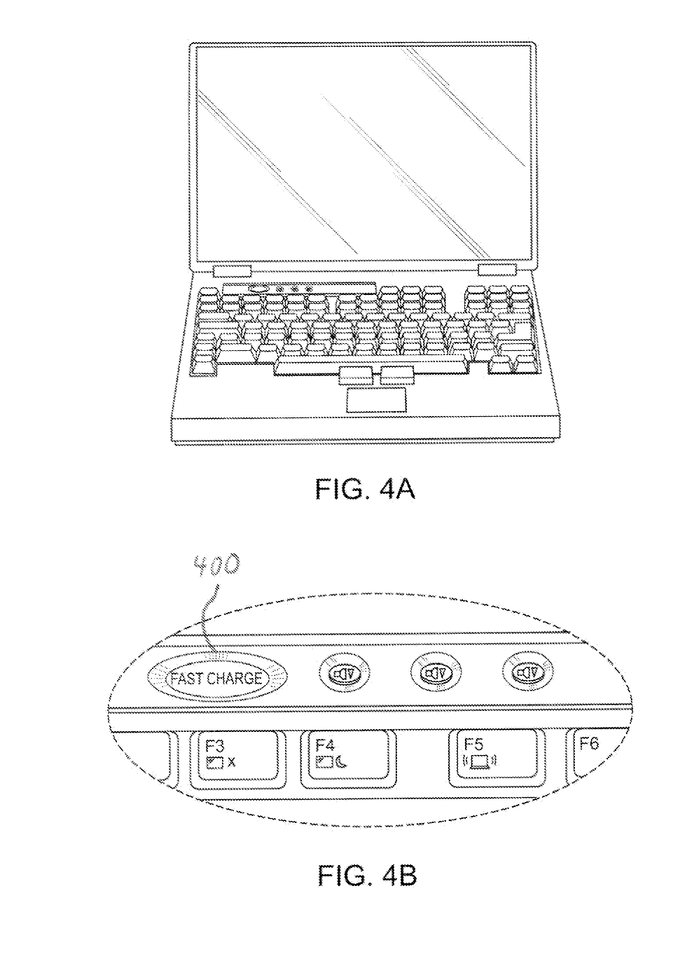

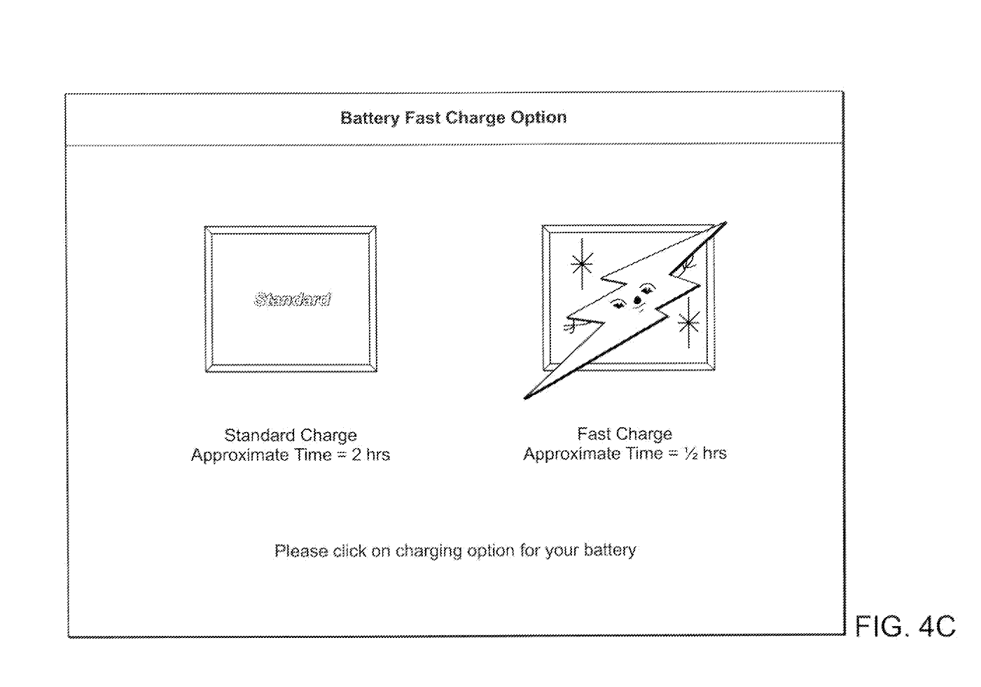

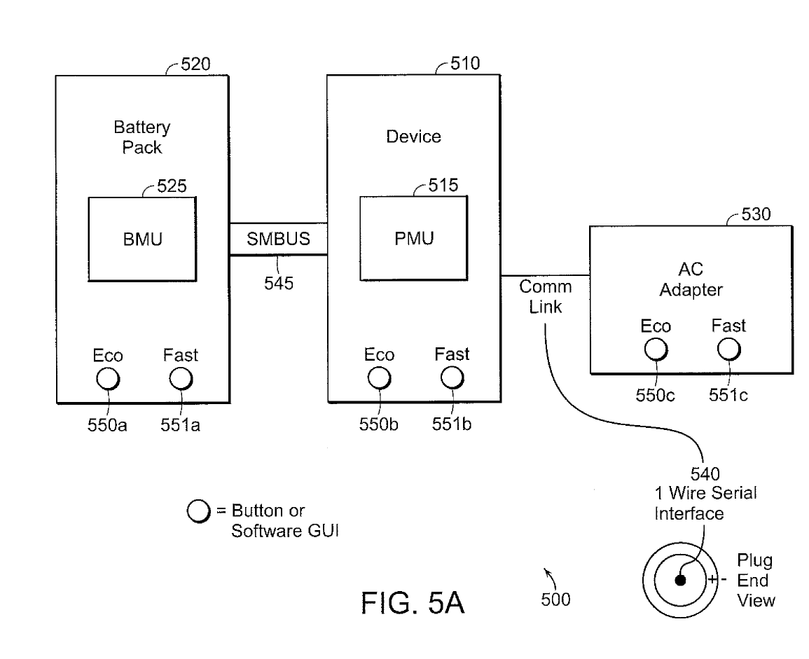

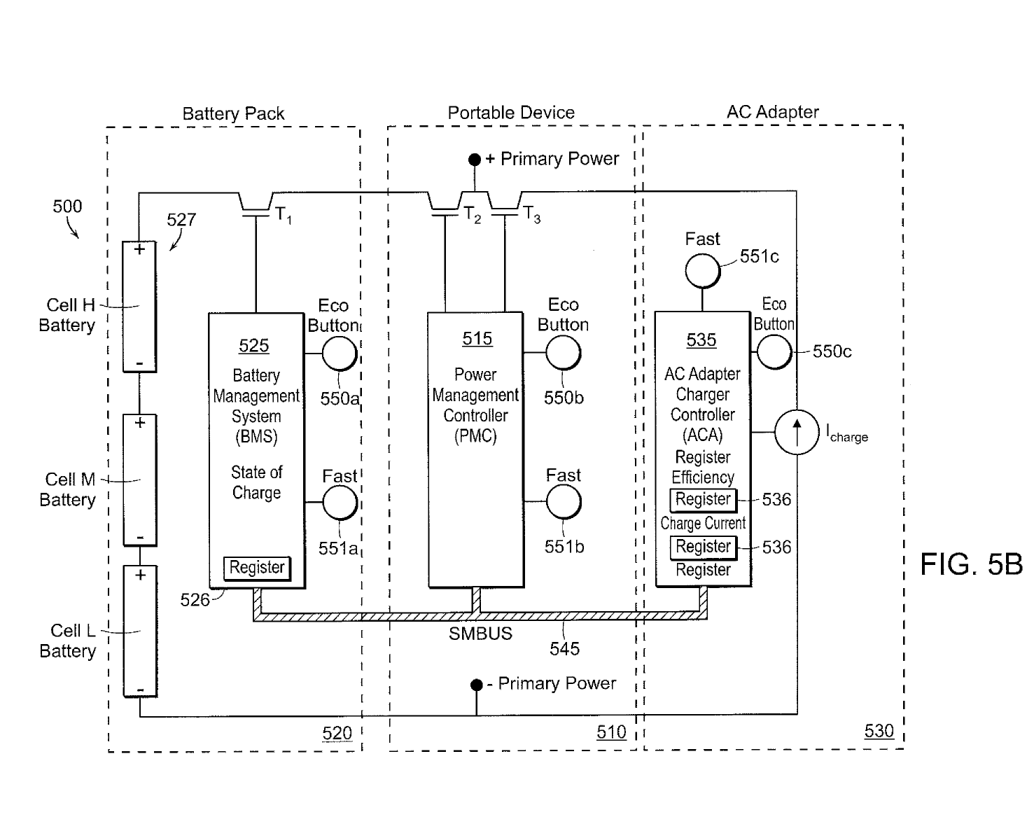

FIG. 3A illustrates a fast charge button 300 on a battery pack upon which the fast charge status of a battery pack may also be displayed. This button 300, when pushed, closes switch 114 (see FIG. 1) and triggers the activation of fast charging, which allows the battery to be charged quicker than would normally be allowed. Select numbers of presses of the button may distinguish different functions controlled through switch 114. The fast charge button 300 could also be implemented through software allowing, for example, the use of a mouse click (see FIG. 4C). The fast charge status of the portable device battery pack may be displayed using a display of light-emitting diodes (LEDs) 202. FIG. 3B provides a close-up view of the aforementioned fast charge button 300 and LED display 302 on a portable device battery pack in accordance with the disclosure.

FIG. 4A illustrates a model laptop have a “FAST CHARGE” button 400 located on the keyboard. FIG. 4B shows a close-up view of the “FAST CHARGE” button located on the model laptop keyboard. FIG. 4C shows an exemplary pop-up window that may appear to present a user with the option of initiating software that will perform the “fast charge” option of the battery. Upon pressing the “FAST CHARGE” button located on the laptop keyboard or through a menu operation of the laptop, the user may be presented with the option of charging the portable device battery pack via standard mode or the fast charge mode. The display could show the approximate times either mode may take. One with skill in the art will understand that the aforementioned statements are only meant to be exemplary in nature and not to limit the scope of the present invention.

The function button brings awareness to electronic device users of the availability of the option of fast charge—compared to the regular charge cycle offered. This button may sit on the face, side or bottom of the laptop device to allow the user to select fast charge. The first step in the process of using the function button is to select the fast charge protocol for a battery pack. Next, the user should select an “activation mode” of circuitry that activates parameters in the electronic circuit having settings suitable for fast charging. The function button may be positioned directly on said battery pack, on the device, in the software, or any combination thereof.

The function button may be implemented with multiple portable power type devices, such as laptop computer, cell phone, DVD player, or camcorder. The purpose of the function button is to allow the user to “fast charge” to a charge that is less than 100% in reduced time. The function button may also be connected to a display that displays parametric values, such as percentage (%) of State of Charge (SOC), time to 100% SOC, estimated charge to partial % SOC, and other parameters related to the user's ability to judge when it is appropriate to prematurely (meaning before 100% SOC) interrupt charging sequence.

The term “switch” includes buttons, physical and display based switches, and can be in the form of knobs, toggles, and the like.

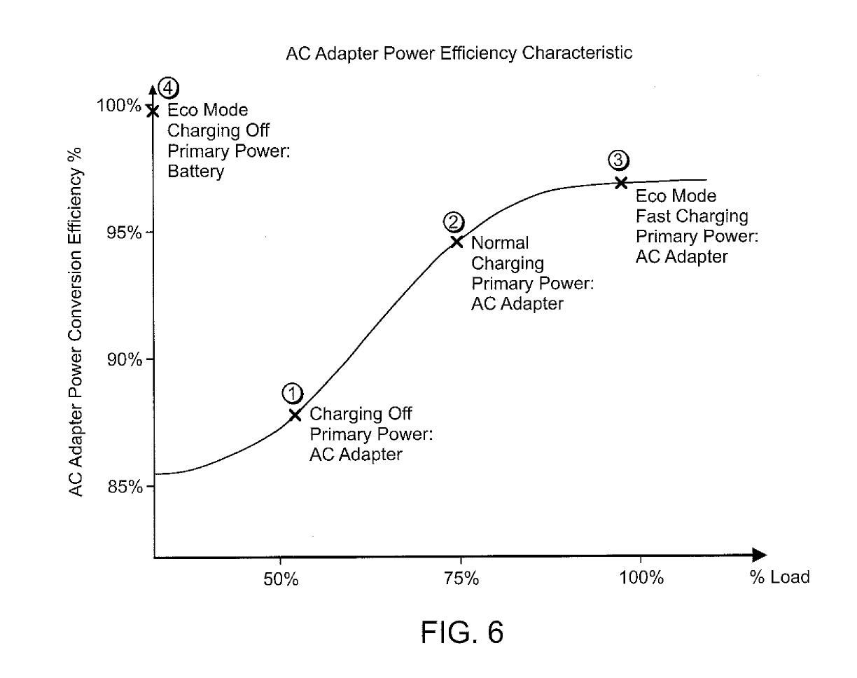

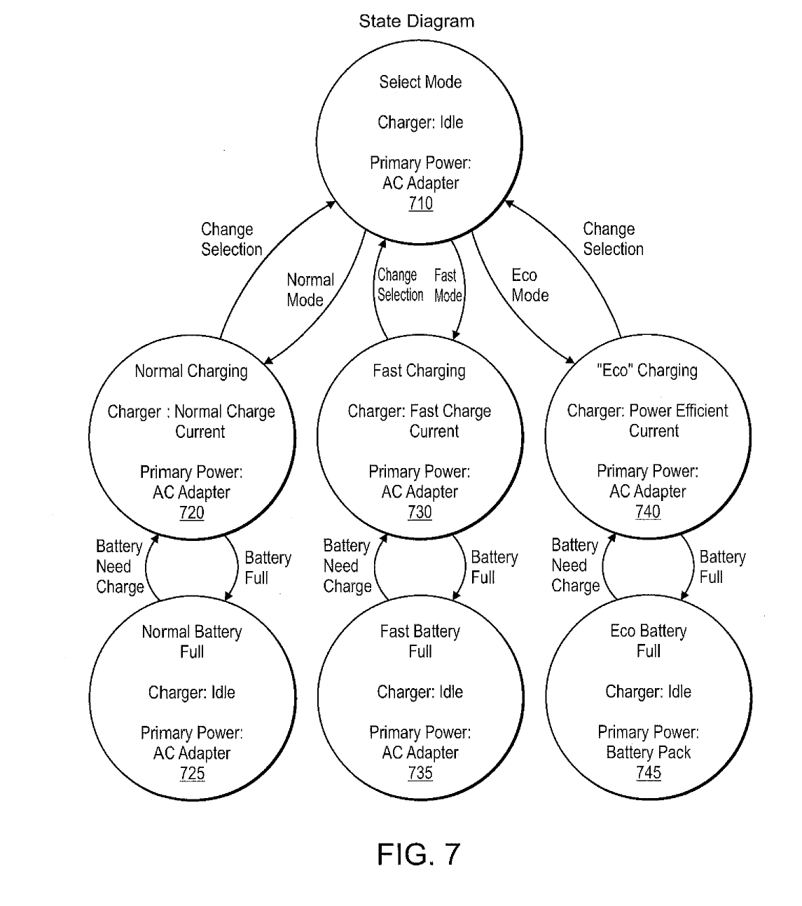

Embodiments of the present invention enable an energy-efficient mode of powering an electronic device and charging/discharging an associated battery by an associated AC adapter. The energy-efficient mode (also referred to as a “green” or “eco” mode) may be initiated and terminated by a user by actuating one or more switches (i.e., a “green button” or “eco button”) located at the battery pack, device and/or AC adapter. The swtiches may be configured in a manner comparable to the “fast charge” switch described above. A user may enter the energy-efficient mode at a convenient time and then returns to a normal, “fast charge” or other mode at a later time. Additional user buttons are located on the battery pack device or AC adapter which select other modes of charging or discharging, such as fast-charge (“high performance”) or normal usage modes. A number of system configurations enabling an energy-efficient power mode, as well as associated methods, are described below with reference to FIG. 5A-FIG. 9C. One or ordinary skill in the art will understand that the electronic circuitry of FIG. 1, the method of FIG. 2 and the devices illustrated in FIGS. 3A-4C may be adapted to enable an energy-efficient power mode as described below.

A software-based GUI (Graphical User Interface) on the device enables similar functionality to the buttons described above. The software GUI has the added benefit of allowing the user to adjust a selected mode over a range, similar to volume slide control in an audio system enhancing the user control as opposed to a simple binary switch selection.

An environment-conserving energy-efficient mode of a battery pack device, and AC adapter can be employed. Upon pressing the eco mode button, the new energy-efficient power state is entered. The battery pack, device and AC adapter operate in a coordinated manner to increase the overall energy efficiency of the combined system. For example, exploiting a well-known property that AC adapters run more efficiently at higher load levels, the AC adapter would be run for a short period of time at high load (with corresponding high efficiency), thereby fast-charging the battery pack, and then switched to an idle stand-by mode. The battery pack would then provide primary power to the system even though the AC adapter is still attached. At a predetermined threshold state of charge, the battery pack would request fast charging from the AC adapter until it is again replenished.

A communication method and protocol to notify the battery pack, device and AC adapter of the selected energy mode (for example, eco fast-charging, high performance, or normal modes) can be employed so that each device can be put into the desired mode even when that mode is activated from another component in the power system. In this manner, the components of the system are enabled to work together to optimize power use for the selected mode. For example, when the user presses the eco button on the AC adapter, the communication method will enable both the notebook PC and battery pack to become notified that the system has entered an energy-efficient eco mode. They will then take appropriate actions to enable energy-efficient operation, such as dimmed display, spinning down optical and hard drives or reducing processor frequency. Furthermore, important conditions of the power state may be communicated between the components. For example, the battery can notify the adapter of its state of charge.

In another example, the adapter may notify the battery and the device of its present energy conversion efficiency and provide guidance on whether to lower, maintain or increase power consumption to improve the energy conversion efficiency.

A connector transfers power and communicates data between an AC adapter and a device or battery pack. In one possible implementation, the connector has a combination of a standard two-conductor barrel-type connection for power transfer and an additional third conductor data connection on which a 1-wire communication protocol is implemented for the communication method described above. In another possible implementation, the AC adapter, device, and battery pack may communicate using standard wireless, infrared, or radio frequency communication techniques.

An indicator shows environmental conservation impact resulting from a currently selected energy-efficiency mode. This could be, for example, a green light indicator or numerical display that shows the equivalent amount of CO2 savings or watt-hours of electrical power conserved.

A dual, triple or higher mode multiple-wavelength light indicator for displaying the current power state on the battery pack, device or AC adapter can be employed. One implementation of the light indicator is a tri-mode LED (Light Emitting Diode) with red (high performance mode), yellow (normal mode) and green (eco mode) colors.

A user button may activate the fast charge mode with the additional ability to cancel the fast charge mode. In this manner, a user enters a fast charge mode at a convenient time and then returns to the normal charge mode at a later time. The fast mode would increase the charging rate to greater than the typical 0.7 C, where C is the capacity of the series cells (for example, a charge rate between 1 C and 2.0 C). Therefore, we a user selects the fast charge mode, the charging rate may be maintained at approximately 1.5 C or a higher rate, and when the user de-selects the fast charge mode or the machine is off, the charging rate may be between 0.5 C to 0.7 C.

More than one external power source (i.e., AC adapter, external DC supply—either a battery or DC/DC adapter) to the notebook may be connected, as desired by or at the convenience of the user. For example, the notebook can support the connection of four (4) AC adapters which can be used to charge the notebook computer simultaneously or independently. When a single adapter is connected, it charges the notebook battery at the normal charge rate. If two or more independent AC adapters are connected, the notebook would have sufficient power to charge the battery at accelerated charge rates.

A new power state for the operating system to enter (other such states are well known and include “hibernate” and “sleep”). Upon pressing the fast charge mode button, the new fast charge power state is entered until a satisfactory charging condition is met (e.g., a constant current cycle has been completed or when the battery reaches a specified state of charge) and then the fast charge power state is deactivated by the operating system. The new fast power state could have a variety of user selectable reduced-power behavior options for the notebook PC, such as dimmed/off display, halt optical drive motor, halt hard drive motor, reduce central processor speed, reduce graphics processing and/or reduce the amount of active system memory.

A user button activates the fast charge mode with the additional ability to cancel the fast charge mode. In this manner, a user can enter a fast charge mode at a convenient time and then return to the normal charge mode at a later time. Closure of the notebook lid can act as a trigger for entering the fast charge mode or the fast charge power state. An AC adapter with enhanced charging ability triggers the notebook to enter fast charge mode using a hardware sense technique or by a software communication to the notebook (e.g., SMBus).

An IC charger includes multiple simultaneous power inputs (e.g., charging simultaneously from an AC adapter and an external battery storage device) and outputs to (e.g., both the notebook and notebook battery pack undergoing fast charging). In one embodiment, a simple circuit rectifies the AC line voltage and directly charges a stack of cells with nominal voltage approximately equal the root-mean-square of the AC voltage magnitude (e.g., 120/sqrt (2) or 240/sqrt (2) V). A notebook may be plugged directly into a POTS (Plain Old Telephone Service) circuit or POE (Power Over Ethernet) to access power from the telephone network.

A device and associated charging circuitry may include the following architecture:
1) An AC adapter—an external device that rectifies the AC line voltage and down converts it to some lower voltage DC output (typically in the 12-24V range)
2) A battery charger IC—an integrated circuit, located within a battery pack or the notebook, which takes the DC input voltage described above and supplies power to the notebook and/or to the battery depending on the requirements of the system at that time. The voltage supplied to the notebook is closely regulated to 4.2V*N, where N is the number of cells connected in series. The supply voltage to the system may be anywhere from 3.0V*N up to the DC input voltage, and may be programmable via external resistors or firmware through a communications interface.
3) A gas gauge and AFE chipset—these are ICs located inside the battery pack that control whether the output of the battery charger IC is connected to the cells.

FIG. 5A is a block diagram of a system 500 including an electronic device and an associated charging system supporting a plurality of charging modes. An electronic device 510 (e.g., a laptop computer or other portable electronic device) is coupled to a battery pack 520 and an AC adapter 530 for selectively powering the device. A Power Management Controller (PMC) 515 at the device 510 is configured to communicate with a battery management system (BMS) at the battery pack 520, as well as the AC adapter 530 to manage powering of the device 510 and charging and discharging of the battery pack. Such communication may be facilitated by a system management bus (SMBUS) 545, which may extend to the AC adapter via a serial communication link 540.

Each of the battery pack 520, device 510 and AC adapter 530, or just one or two of them, may include one or more switches 550a-c, 551a-c (implemented as software and/or physical interfaces) accessible to a user for initiating one or more different modes of charging the battery pack 520 and providing power to the device 510. The buttons may include switches 550a-c for initiating and/or terminating an energy efficient (“eco-charge”) mode, as well as switches for initiating and/or terminating a “fast” charge mode, such as the fast charge mode described above with reference to FIGS. 2-4C. The system 500 is described in further detail below with reference to FIG. 5B.

FIG. 5B is a block diagram showing the system 500 of FIG. 5A in further detail. The battery pack 520 includes a battery management system (BMS) 525, which regulates the charging and discharging of the battery 527 (comprising a number of power cells). The BMS 525 may include some or all of the circuitry 100 as described above with reference to FIG. 1. The BMS 525 may further include one or more registers 526 configured to store information regarding characteristics of the battery 527 (e.g., capability of charging at a high rate during a “fast” or “eco” charge), state of charge of the battery 527, and/or an indicator of the charge mode presently selected. The BMS may facilitate charging and discharging of the battery 527 by controlling a switch T1 (e.g., a transistor) to control a corresponding circuit.

The AC adapter 530 includes an AC adapter charger controller (ACA) 535, which is configured to control operation of the AC adapter 530, including output current I_{charge}, according to a selected power mode. The ACA 535 may further include a plurality of registers 536 configured to store information regarding operation of the AC adapter 530, including operating efficiency, charge current and/or and indicator of the charge mode presently selected.

The electronic device 510 includes a power management controller (PMC) 515, which manages power to the device 510 as well as the power mode (e.g., normal, “fast” charge and “eco” mode) as selected by a user. The PMC 515 may include some or all of the circuitry 100 as described above with reference to FIG. 1. The PMC 515 controls power to the remaining circuitry of the device (not shown) at the “primary power nodes” via switches T2, T3 (e.g., transistors).

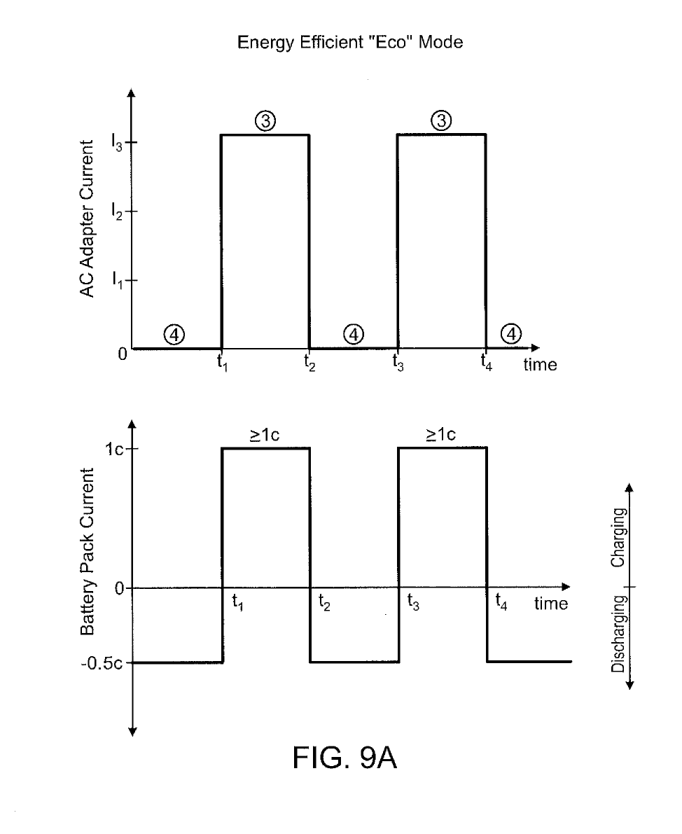

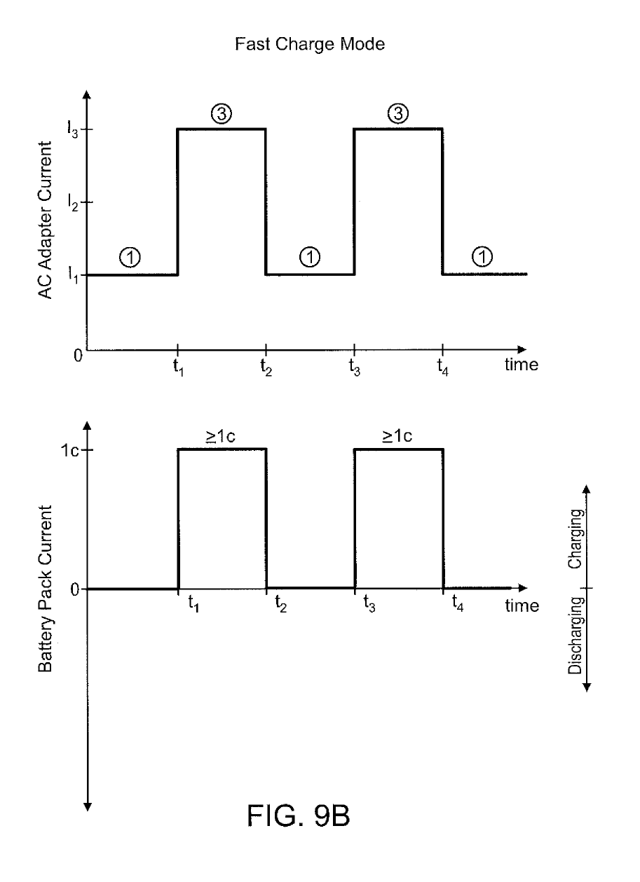

The PMC 515 may be configured further to determine a selected power mode according to user input, and communicate with the BMU 525 and ACA 535 via the system management bus (SMBUS) 545 to transition the entire system 500 between a number of power modes. For example, a user may actuate one of the switches 550b, 551b located at the device 510 to enter either a energy-efficient (“eco”) power mode or a fast charge mode, respectively. (Alternatively, actuating a switch 550b, 551b may exit a particular mode, returning to a “normal” charge mode.) In response, the PMC communicates the selected mode to the BMS 525 and the ACA 535, which in turn operate the battery pack 520 and AC adapter 530, respectively, according to the selected mode. Methods relating to the “fast charge” mode are described above with reference to FIG. 2; methods relating to the “eco” power mode are described below with reference to FIGS. 8A and 8B. Alternatively, a user may actuate a switch 550a, 551a located at the battery pack, or a switch 550c, 551c located at the AC adapter, to enter or exit a “fast” charge mode or an “eco” power mode. In such a case, either the BMS 525 or the ACA 535 may detect the selection and communicate the same to the PMC 515 for transitioning a power mode as described above.

In further embodiments of the invention, the system 500 may include a plurality of power sources (not shown) in addition to the AC adapter 530, the PMC selecting from among the power sources to charge the battery and provide power to the device 510. Additional power sources may include a DC-to-DC power adapter, external battery, an additional AC-to-DC adapter, or another power device. In selecting among the power sources, the PMC may include logic to determine an optimal energy efficiency based on a number of inputs, including energy efficiency of the power sources at a given current output and a maximum current output of the power sources. Moreover, a plurality of power sources may be recruited in combination to provide the selected high current to charge the battery 527 at a high rate.

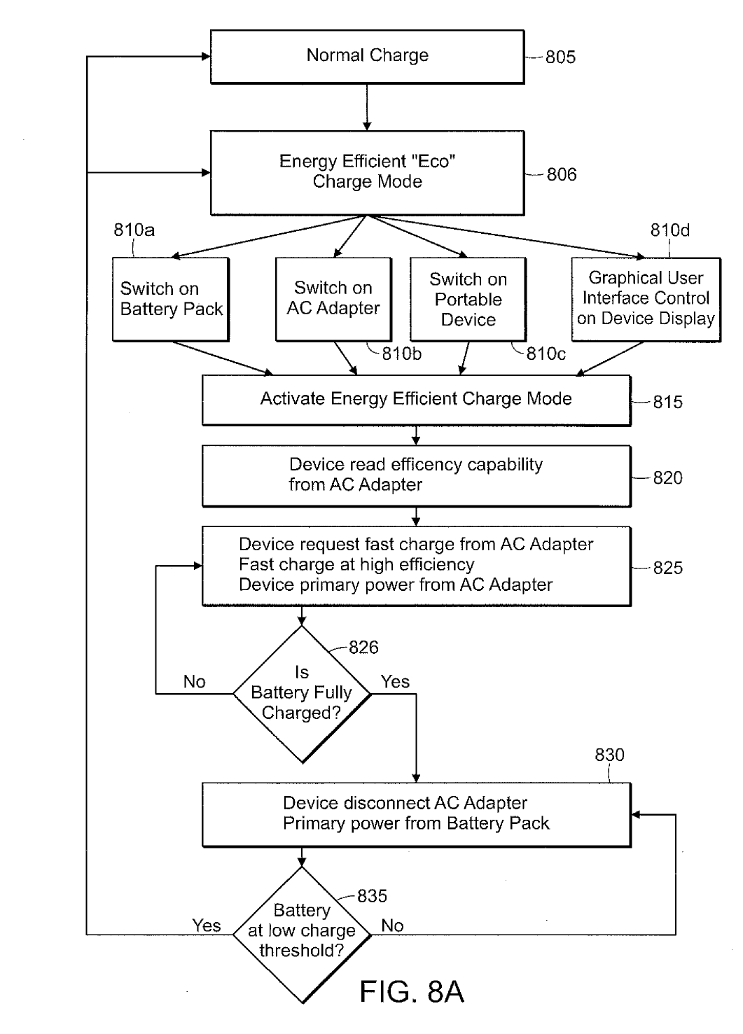

FIG. 6 is a chart depicting a relation between power efficiency and operating load of an AC power adapter. The relation as shown is intended to illustrate a general principle of efficiency versus load exhibited by some AC-to-DC power adapters, and is not necessarily to scale, nor accurate with regard to a particular AC adapter of an embodiment of present invention.

As indicated by FIG. 6, an AC adapter may exhibit much higher efficiency in power conversion when operating at a higher load than when operating at a lower load. As a result, different modes of operation may correspond to different efficiencies. With reference to the system 500 of FIG. 5B, for example, when charging a battery is disabled and the device is powered entirely through the AC adapter, the AC adapter operates at a low load (e.g., 50%), resulting in a lower efficiency (e.g., 87%) (1). During a normal charge (the AC adapter is providing current both to charge the battery and power the device), the load at the AC adapter is relatively higher (e.g., 75%), resulting in a higher efficiency (e.g., 93%) (2). Further, an energy-efficient (“eco”) power mode may transition periodically between two states: a first mode where the battery is charged at a high rate (e.g., above 1 C) and the device is powered by the AC adapter (3); and a second mode where charging is disabled and the device is powered by the battery (4). As a result, an “eco” power mode provides for utilizing an AC adapter at a high efficiency while operating the device and charging the battery.

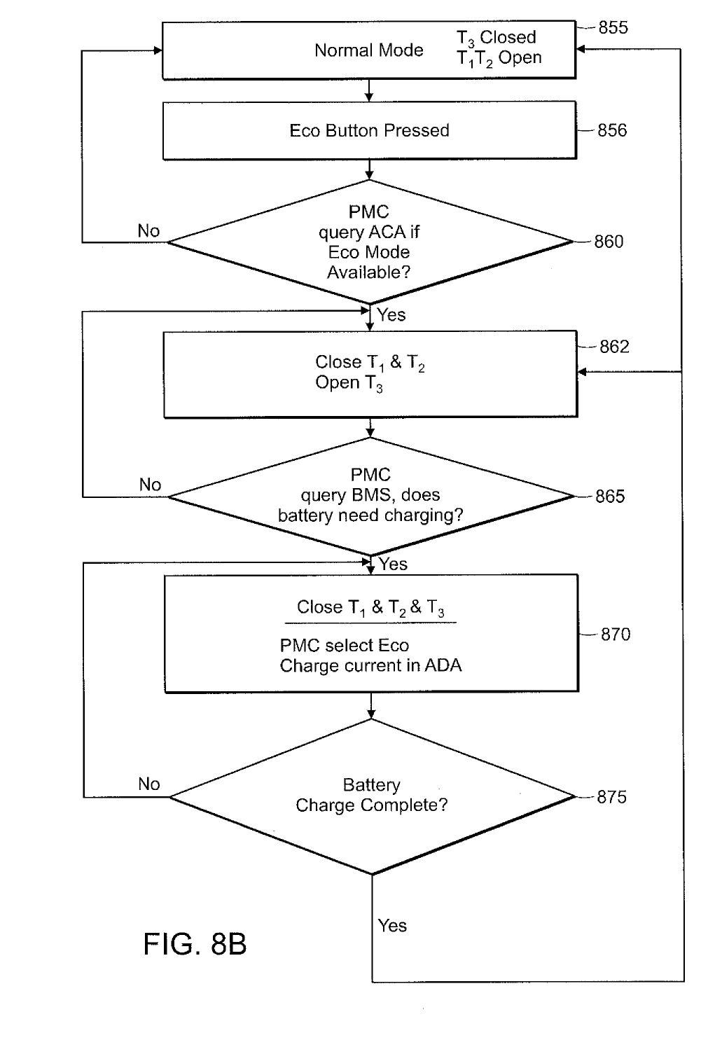

FIG. 7 is a state diagram illustrating a plurality of modes for charging a battery. In an initial (“non-charging”) state 710, a device and associated charging circuitry (e.g., the system 500 of FIGS. 5A-B) relies primarily on an AC adapter to power the device, while the charger remains idle, meaning that the battery is disconnected from charging or discharging. From the initial state 710, the system may enter one of a plurality of states for charging the battery and powering the device, and enters the state in response to a user selection (e.g., actuating a switch). In a “normal charging” state 720, the battery is charged at a normal charge current, while the device is powered by the AC adapter. When the battery is detected to have reached full charge, the battery charger becomes idle, and the device continues to rely on power from the AC adapter (725). In the event that the AC adapter is disconnected, the device will transition to utilize power from the battery.

In a “fast charging” state 730, the battery is charged at a high charge current, while the device is powered by the AC adapter. When the battery is detected to have reached full charge, the battery charger becomes idle, and the device continues to rely on power from the AC adapter (735). In an energy-efficient “eco” power state 740, the battery is charged at a charge current determined to operate the AC adapter at a high efficiency (e.g., a maximum safe current), while the device is powered by the AC adapter. When the battery is detected to have reached full charge, the battery charger becomes idle, and the transitions to draw power from the battery rather than the AC adapter (745). As a result, operation in the “eco” power states 740, 745 utilizes the AC adapter at a higher efficiency (see, e.g., FIG. 6).

FIG. 8A is a flow diagram illustrating a method of initiating an energy-efficient (“eco”) power mode, which may be implemented by the system 500 provided in FIGS. 5A-B. Prior to initiating this mode, the system may be configured in a “normal charge” or other state (805). A user initiates the “eco” power mode (806) through a graphical user interface on a display associated with the device (810d), or by actuating a switch on the battery pack (810a), the AC adapter (810b) or the device (810c). Accordingly, the system activates the “eco” power mode (815).

At the onset of the “eco” power mode, the system may retrieve information regarding the operation and efficiency attainable by the connected AC adapter (820). Such information may be available at one or more registers at the AC adapter, and may be used to determine an operating current for the AC adapter. Thus, an operating current known to enable high efficiency of the AC adapter can be selected. The device (e.g., a power management controller (PMC) within the device) may then communicate with the AC adapter (e.g., AC adapter charger controller (ACA)) to request the aforementioned operating current to enable a “fast,” energy-efficient charge from the AC adapter (825). During this charge of the battery, the device draws primary power from the AC adapter, further increasing the load at the AC adapter, which, in turn, may further increase the efficiency of the AC adapter.

This state of charge continues until the battery is fully charged (826). The state of battery charge may be monitored at the battery pack by the battery management unit (BMU), which in turn may indicate the state of charge at a register to be read by the PMU. Upon reaching a full charge, the device disconnects the AC adapter from the primary power input, connecting the battery pack to draw power in its place (830). The device continues to draw primary power from the battery until the battery reaches a “low charge” threshold (835). In response, the system may return to a “normal charge” mode (805), “eco” power mode (806) or other mode to charge the battery and continue providing power to the device.

FIG. 8B is a flow diagram illustrating a method of conducting an energy-efficient charge mode, which may be implemented by the system 500 provided in FIGS. 5A-B. The method may include one or more operations as described above with reference to FIG. 8A, and may relate to operations at the BMS 525, PMC 515 and ACA 535 described above with reference to FIGS. 5A-B.

With reference to FIG. 5B, during “normal” operation mode for powering the device 510 using the AC adapter 530, the PMC 515 and BMS 525 control switch T3 to be closed and switches T1, T2 to be open, thereby connecting the AC adapter 530 to the primary power node to the device 510 (855). In response to detecting that an “eco” mode switch is actuated (856), the PMC queries the ACA to determine whether the AC adapter 530 supports operation in the “eco” power mode (860). This determination may be made based on characteristics of the AC adapter 530 (e.g., maximum current output), which may be indicated at one of the registers 536. If the “eco” power mode is available, then the BMS 525 closes switch T1 and the PMC 515 opens switch T3 and closes switch T2, thereby connecting the battery 527 to the primary power node of the device 510 (862). Thereafter, the PMC 515 continually or periodically queries the BMS to determine whether the battery needs to be charged (865). This determination may be made by comparing a state of charge of the battery 527 (as indicated by the register 526) against a low-charge threshold. If a charge is needed, then the BMS 525 and PMC 515 close switches T1, T2, T3, connecting the AC adapter 530 current source to both the primary power node of the device 510 and the battery 527 (870). Further, the ADA 535 selects a high current output associated with the energy-efficient “eco” power mode.

The battery charge may be determined to be complete when the state of battery charge, as indicated by the BMS 525, reaches a given threshold (875). Upon completion, the device may return to utilizing the battery for primary power (862), repeating a cycle of discharging the battery (865) followed by charging the battery under a high-current “eco” charge mode (870). This cycle may be repeated indefinitely provided that the “eco” switch remains actuated by a user. Alternatively, the system 500 may return to a “normal” power mode, relying on the AC adapter 530 to provide primary power to the device 510 (855)

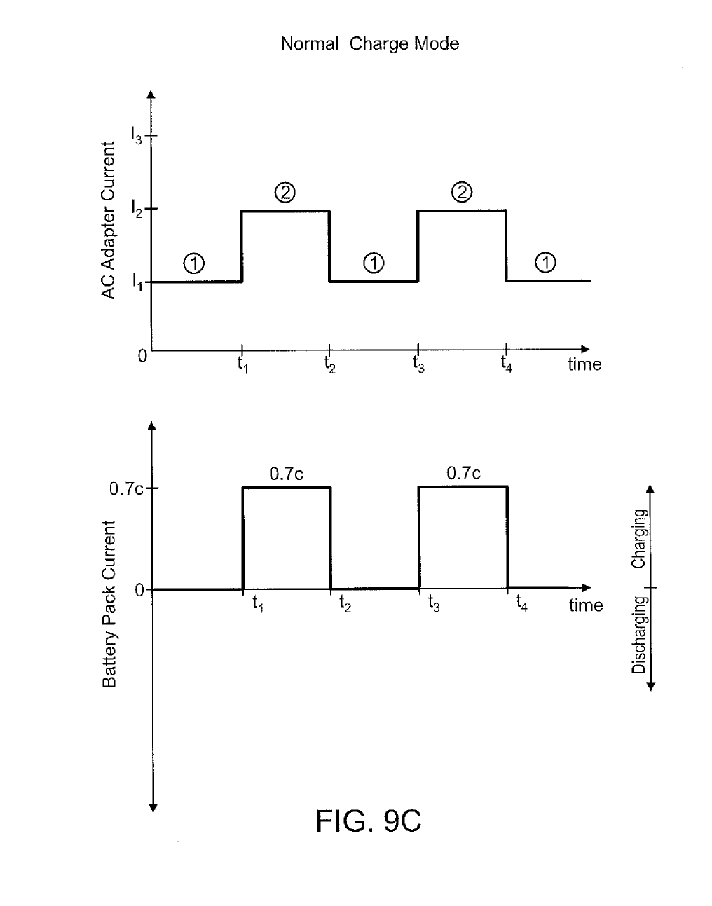

FIGS. 9A-C are timing diagrams illustrating AC adapter current and battery pack current during each of a plurality of charge modes. Relative current corresponds to the numbered designations shown in FIG. 2, but are not shown to scale. FIG. 9A illustrates AC adapter current and battery pack current during several cycles of an “eco” power mode as described above with reference to FIG. 8B. At times 0-T1, T2-T3 and T4+, the AC adapter is disconnected from the battery pack and the device, and thus provides no current output (4). Accordingly, the battery provides power to the device, discharging the battery at a rate of 0.5 C (variable dependent on load at the device). At times T1-T2 and T3-T4, the AC adapter provides a high current output 13, providing both for charging the battery at a rate of 1 C or greater and powering the device (3).

FIG. 9B illustrates AC adapter current and battery pack current during several cycles of a “fast” charge mode. At times 0-T1, T2-T3 and T4+, charging of the battery is disabled, and the AC adapter provides primary power to the device (1). Accordingly, there is no current output at the battery. At times T1-T2 and T3-T4, the AC adapter provides a high current output 13 (which may be equal to or distinct from the current 13 provided in the “eco” power mode), providing both for charging the battery at a rate of 1 C or greater and powering the device (3).

FIG. 9C illustrates AC adapter current and battery pack current during several cycles of a “normal” charge mode. At times 0-T1, T2-T3 and T4+, charging of the battery is disabled, and the AC adapter provides primary power to the device (1). Accordingly, there is no current output at the battery. At times T1-T2 and T3-T4, the AC adapter provides a normal current output 12, providing both for charging the battery at a “normal” rate of 0.7 C and powering the device (2).

While this invention has been particularly shown and described with references to example embodiments thereof, it will be understood by those skilled in the art that various changes in form and details may be made therein without departing from the scope of the invention encompassed by the appended claims.

What is claimed is:

1. A method of providing power to an electronic device, comprising:
upon detecting a battery reaching a high threshold state of charge, entering a first power state by switching a circuit to disable current at an AC-to-DC adapter to enable the battery to provide primary power to the electronic device;
upon detecting the battery reaching a low threshold state of charge, entering a second power state by switching the circuit to provide a high current at the AC-to-DC adapter to charge the battery and provide primary power to the electronic device.

2. The method of claim 1, wherein the AC-to-DC adapter charges the battery at a high rate in the second power state, the high rate being greater than 1 C.

3. The method of claim 2, wherein the high rate is greater than 1.5 C.

4. The method of claim 2, further comprising detecting whether the battery is capable of being charged safely at the high rate prior to entering the second power state.

5. The method of claim 1, further comprising returning to the first power state upon detecting the battery reaching a high threshold state of charge.

6. The method of claim 1, further comprising alternating between the first and second power states in response to detecting the high and low threshold states of charge over time.

7. The method of claim 1, further comprising enabling the first and second power states in response to a user selection of an energy-efficient power mode to power the electronic device.

8. The method of claim 7, further comprising entering a third power state in response to a user selection of a power mode other than the energy-efficient power mode, the charge mode being one of a normal power mode and a fast charge mode.

9. The method of claim 7, further comprising entering a third power state prior to the user selection by switching the circuit to provide a low current at the AC-to-DC adapter to charge the battery at a low rate and provide primary power to the electronic device.

10. The method of claim 9, wherein the low rate is less than 1 C, and the high rate is greater than 1 C.

11. The method of claim 9, wherein the AC-to-DC adapter operates at a higher energy efficiency at the high current than at the low current.

12. The method of claim 1, further comprising detecting whether the AC-to-DC adapter is capable of providing the high current prior to entering the second power state.

13. The method of claim 1, wherein the battery is a lithium ion (Li-ion) battery.

14. The method of claim 1, further comprising selecting a rate of the AC-to-DC adapter current output based on characteristics of the AC-to-DC adapter and characteristics of the battery.

15. The method of claim 14, wherein the characteristics of the AC-to-DC adapter include a maximum current output, and the characteristics of the battery include a maximum safe charge rate.

16. The method of claim 14, wherein the characteristics of the AC-to-DC adapter include a predicted energy efficiency corresponding to a given current output.

17. The method of claim 1, further comprising selecting among a plurality of AC-to-DC adapters to provide the high current in the second power state, the selection being based on an indication of maximum output current at each of the plurality of AC-to-DC adapters.

18. The method of claim 1, further comprising selecting among a plurality of power sources to provide the high current in the second power state, the selection being based on an indication of maximum output current at each of the plurality of power sources, the power sources including one or more of an AC-to-DC adapter, a DC-to-DC adapter, and an external battery.

19. The method of claim 18, wherein the selection is based on energy efficiency corresponding to a given current output at each of the plurality of power sources.

20. An apparatus for providing power to an electronic device, comprising:
a power circuit configured to enable and disable power to the electronic device from a battery and an AC-to-DC adapter;
a controller coupled to the power circuit and configured to transition between first and second states, the first state including disabling current at the AC-to-DC adapter and enabling the battery to provide primary power to the electronic device in response to detecting a high threshold state of charge, the second state including enabling the AC-to-DC adapter to provide primary power to the electronic device and charging the battery in response to detecting a low threshold state of charge.

21. A system for providing power to an electronic device, comprising:
a battery configured to provide power to an electronic device;
an AC-to-DC adapter configured to provide power to the electronic device; and
a controller configured to transition between first and second states, the first state including disabling current at the AC-to-DC adapter and enabling the battery to provide primary power to the electronic device in response to detecting a high threshold state of charge, the second state including enabling the AC-to-DC adapter to provide primary power to the electronic device and charging the battery in response to detecting a low threshold state of charge.
